(19) United States
(12) Patent Application Publication
(10) Pub. No.: US 2026/0155696 A1
(43) Pub. Date: Jun. 4, 2026

(54) METALLIC WEDGE BLOCK WITH INTEGRATED INSULATED END CAPS TO PREVENT ELECTRICAL ARCING IN DYNAMOELECTRIC GENERATORS

(71) Applicant: Cory Jon Goodspeed, Gloversville, NY (US)

(72) Inventor: Cory Jon Goodspeed, Gloversville, NY (US)

(21) Appl. No.: 18/967,421

(22) Filed: Dec. 3, 2024

(51) Int. Cl. H02K 3/487

(52) U.S. Cl. CPC H02K 3/487

(57) ABSTRACT

A metallic wedge block with integrated end cap insulation serves as a coil winding retention system for large dynamoelectric machines with axially extending radial slots containing windings. This invention mitigates electrical arc strikes and localized heating by addressing deficiencies in traditional wedge designs using advanced insulation materials. It minimizes pitting, enhances thermal management, and extends the generator's operational lifespan.

The design ensures compatibility with existing systems, enabling retrofitting without significant modifications. Metallic wedge blocks are arranged end-to-end to restrain windings and electrically insulate adjacent wedges via integrated end cap insulation. This insulation prevents arc strikes during negative sequence events and reduces thermal load by eliminating localized heating. The resulting assembly eliminates pitting and improves efficiency by addressing thermal loads caused by electrical discharges.

### REFERENCES CITED

### U.S. Patent Documents

U.S. Pat. No. 3,139,550A June 1964 Geer . . . 310/214

U.S. Pat. No. 3,740,601 June 1973 Amasino . . . 310/214

U.S. Pat. No. 3,391,294 January 1966 Moxie et al . . . 310/214

U.S. Pat. No. 4,015,156 March 1977 Johrde et al . . . 310/214

U.S. Pat. No. 8,018,114B2 September 2011 Rasmussen et al H02K3/487

### Foreign Patents or Applications

CA591,672A February 1960 Canada . . . 310/214

GB1022842 March 1966 United Kingdom . . . 310/214

EP3046230A September 2018 Europe . . . H02K3/487

### NON-PATENT LITERATURE

Zawoysky, R. J., and Tornroos, K. C., “GE Generator Rotor Design, Operational Issues, and Refurbishment Options,” GE Power Systems, GER-4212, 2001.

### 13 Claims, 18 Drawings

### BACKGROUND OF THE INVENTION

### Technical Field

This invention relates to the mitigation and prevention of electrical arcing occurring at the end faces of coil wedges in rotating generator rotors, caused by negative sequence events. The invention additionally decreases the generator's thermal load by eliminating localized heating resulting from these arc strikes, thereby improving overall operational efficiency.

In conventional generator designs, coil wedges primarily secure the rotor's windings mechanically, typically lacking integrated electrical insulation features. The prior art, including U.S. Pat. No. 4,015,156, focuses on insulating systems and locking mechanisms for securing wedges in place but does not address the specific design, construction, or operational challenges associated with insulating the wedge itself. Unlike prior solutions, this invention provides a metallic wedge block with integrated end cap insulation specifically engineered for arc mitigation, pitting prevention, and thermal management, offering a unified solution to these critical operational challenges.

### RELATED ART

### Generator Rotor Efficiency

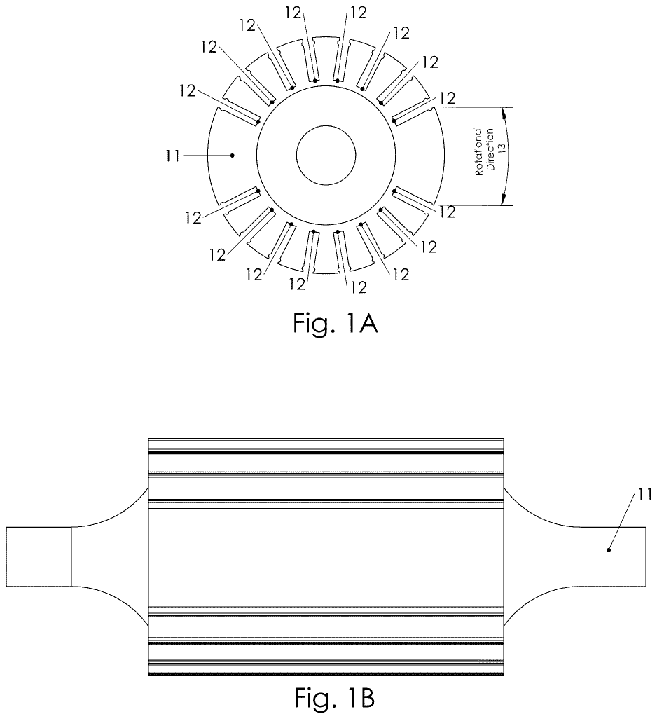

A dynamoelectric machine, commonly referred to as an electric generator, contains a rotor, which is a critical component of the generator. The rotor is typically made from a solid steel forging and is designed to rotate within the stator to produce the electromagnetic fields necessary for energy conversion. This forging is illustrated in the related art by FIG. 1A and FIG. 1B.

FIG. 1A illustrates prior art of a generator rotor (11), viewed from an end view along the axis of rotation (13), showing a typical plurality of axially extending radial slots (12) arranged about the periphery.

FIG. 1B depicts the same prior art rotor (11) from FIG. 1A, viewed orthogonally to the rotor's axis for clarity.

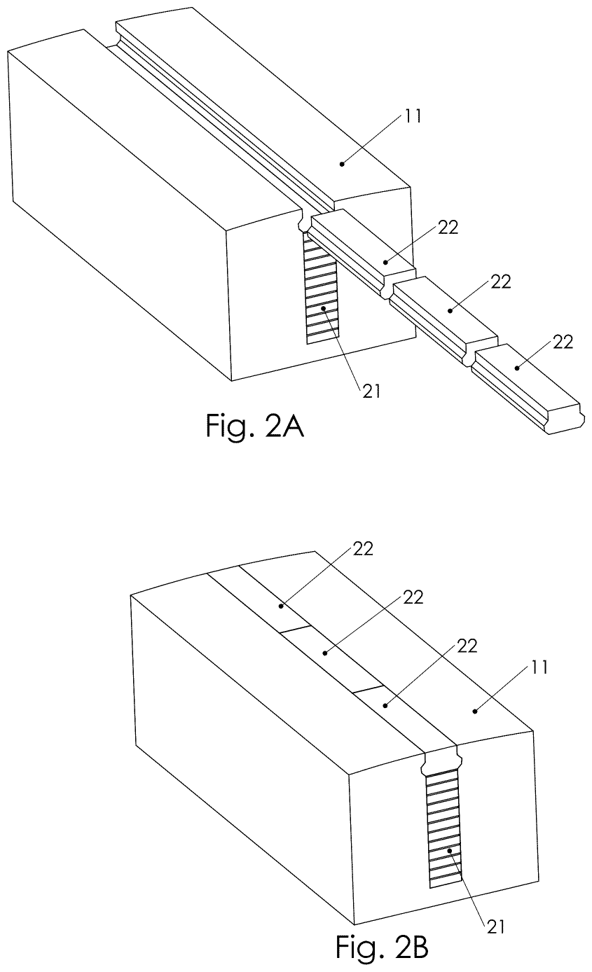

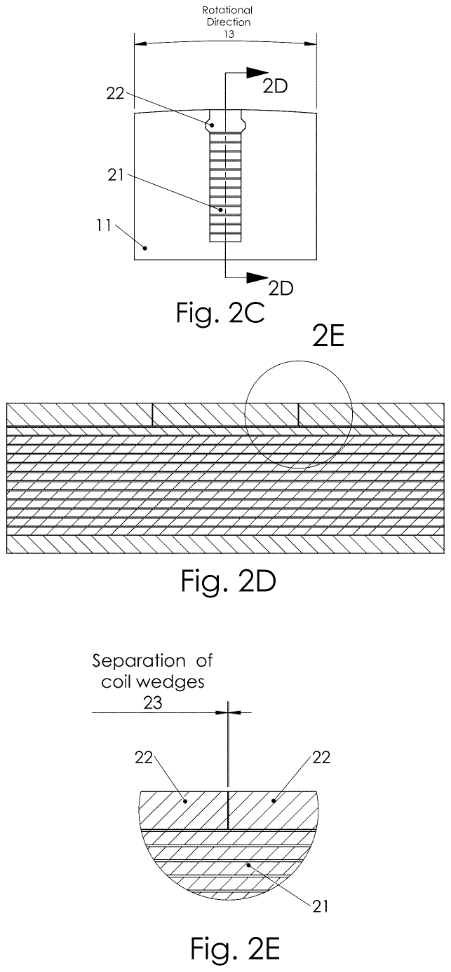

The rotor contains winding stacks (21) that, when energized, create the magnetic field essential for generating electricity. To prevent outward movement due to centrifugal forces, these winding stacks (21) are retained within their respective radial slots (12) by traditional metallic coil wedges (22), as best illustrated in FIG. 2A through FIG. 2E.

FIG. 2A provides a partially isometric longitudinal section view of a rotor (11) with a radial slot (12) containing a coil winding stack (21) installed in an operational position. For clarity, the traditional metallic coil wedge (22) is depicted removed from the rotor.

FIG. 2B shows the same rotor (11) and radial slot (12) with the coil winding stack (21) installed, now including traditional metallic coil wedges (22) in their operational positions.

FIG. 2C presents the same prior art as FIG. 2B, viewed from an end view along the axis of rotation (13) for clarity.

FIG. 2D provides a sectional view radially through the traditional metallic coil wedges (22) and coil winding stack (21) within the radial slot (12).

Negative sequence events occur when there is an imbalance in the power system, leading to uneven electrical currents. These currents flow in the opposite direction of the rotor's rotation (13), creating additional stresses on the rotor's windings and body. Such imbalances cause excessive heating and reduce the overall efficiency of the generator. The excessive heat and rotational stresses generated by unbalanced currents can cause the wedges to shift and lose contact with adjacent wedges. This separation creates gaps, where during a negative sequence event, arc strikes can occur between the end faces of traditional metallic coil wedges (22).

FIG. 2E illustrates traditional metallic coil wedge (22) separation (23), showing the end faces of adjacent wedges separated in an operational state within the radial slot (12).

Over time, the rotor's surface may experience mechanical pitting and damage from arc strikes, as the current irregularities create localized high-temperature spots. These thermal and mechanical stresses weaken the rotor forging, causing microscopic pits and cracks. This degradation reduces the generator's lifespan and increases the risk of failure.

### Traditional Metallic Coil Wedge Retaining Devices

Prior art traditional metallic coil wedges (22) in a generator rotor (11) serve a crucial function by securing the coil winding stack (21) in place within the rotor's radial slots (12), preventing movement caused by centrifugal forces during operation.

Conventionally, prior art traditional metallic coil wedges (22) are fabricated from materials such as aluminum or steel, which are widely used due to their strength and durability. Traditional metallic coil wedges (22) ensure structural integrity by securely retaining coil winding stacks (21) within their designated positions in the rotor's radial slots (12) as the rotor (11) rotates (13) during normal operation. However, while these materials provide mechanical stability, they lack adequate electrical insulation properties, making them prone to challenges related to mitigating electrical discharge and heat dissipation during operation.

During a negative sequence event, where an imbalance in the electrical current causes uneven forces on the windings, the stability of the traditional metallic coil wedges (22) can be compromised. The excessive heat and rotational stresses generated by unbalanced currents can cause the traditional metallic coil wedges (22) to shift and separate (23) from adjacent wedges, creating gaps. Within these gaps, arc strikes can occur as intense electrical discharges jump between adjacent traditional metallic coil wedges (22), seeking the path of least resistance. Such arcs erode the material on the wedge surfaces, further reducing the rotor's performance and creating risks of catastrophic damage if the arcs penetrate insulation and reach the copper windings.

The cumulative effect of arc strikes includes pockets of localized heating, which can severely compromise the mechanical and electrical integrity of the rotor (11), leading to reduced efficiency, higher maintenance costs, and the potential for rotor failure.

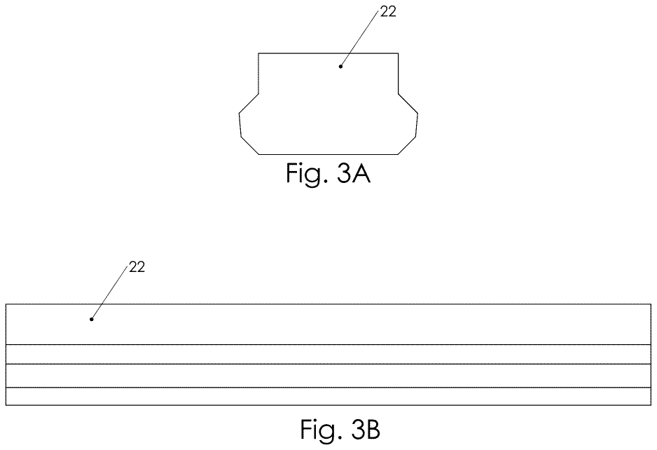

FIG. 3A shows a typical design of a prior art traditional metallic coil wedge (22), viewed from an end view along the rotor (11) axis of rotation (13). This figure highlights the end face of the traditional metallic coil wedge (22), which is vulnerable to arc strikes.

FIG. 3B depicts a typical design of a prior art traditional metallic coil wedge (22), viewed orthogonally to the rotor (11) axis of rotation (13).

U.S. Pat. No. 4,015,156 describes a slot wedge system employing insulating components for securing wedges and preventing axial movement within the rotor's radial slots. While effective for its intended purpose, it does not address the problem of electrical arcing at wedge end faces or the resultant mechanical pitting and localized heating. The present invention fundamentally differs by targeting the metallic wedge block itself, integrating insulation to mitigate electrical discharge and optimize thermal performance. By insulating the wedge ends and affixing these components securely, this invention solves issues left unaddressed by prior art.

### SUMMARY OF THE INVENTION

### Summary of the Problem in the Prior Art

As discussed, supra, prior art traditional metallic coil wedges (22) serve as crucial components in electric generators, securing the coil winding stack (21) within the radial slots (12). These wedges prevent the windings from moving due to the immense centrifugal forces generated during high-speed rotation (13). Traditionally, metallic coil wedges (22) are predominantly fabricated from aluminum or steel, valued for their high mechanical strength and durability. These metals provide the structural integrity necessary to endure the extreme physical stresses of generator operation. However, while effective in maintaining mechanical stability, traditional metallic wedges exhibit significant shortcomings in electrical and thermal insulation performance.

One of the primary issues with traditional metallic coil wedges (22) is their inability to adequately mitigate electrical discharges during generator operation. Without sufficient insulation, electrical arcing frequently occurs, particularly during negative sequence events caused by imbalanced currents. These arcs primarily arise at separations (23) between traditional metallic coil wedges (22), particularly on their end faces, as illustrated in FIG. 3A. Such electrical arcing leads to pitting and degradation of the metallic surfaces, compromising the mechanical integrity of the rotor (11) over time. Moreover, the lack of thermal insulation intensifies this issue, as traditional metallic coil wedges (22) fail to dissipate heat effectively, resulting in thermal stress within the generator.

Without proper insulation, traditional metallic coil wedges (22) contribute to progressive electrical degradation, directly impacting the generator's efficiency. Repeated electrical arcing combined with pitting and mechanical wear reduces the operational lifespan of the generator, increasing maintenance requirements and costs. Although traditional metallic coil wedges (22) perform well in handling mechanical loads, they fail to address the critical risks associated with electrical discharge mitigation and thermal management.

This issue is well-documented in General Electric publication GER-4212: GE Generator Rotor Design, Operational Issues, and Refurbishment Options, authored by Ronald J. Zawoysky and Karl C. Tornroos from GE Power Systems, Schenectady, NY. Specifically, during inspections of seventeen large steam turbine generators, two were found to have experienced negative sequence events while in service. In both cases, arc strikes were identified between the traditional metallic coil wedges (22) and the mating surfaces of the rotor's (11) radial slot (12) teeth, particularly on the load surfaces of the wedges, as depicted in FIG. 3A.

### Solution of the Problem by the Present Invention

Given the limitations of existing coil wedge designs, there is a clear need for innovation to address both mechanical stability and electrical insulation challenges in generator rotors. The present invention introduces a metallic wedge block (42,45) with integrated end cap insulation (43,46), addressing challenges left unresolved by prior art, such as U.S. Pat. No. 4,015,156. Unlike the prior art, which focuses on securing wedges (22) mechanically without addressing thermal or electrical degradation, this invention mitigates arc strikes at wedge end faces through integrated insulation (43,46). The insulation (43,46) also enhances thermal dissipation by utilizing low-conductivity materials, preventing localized heating and extending generator lifespan. These combined features represent a significant advancement over existing solutions. This design ensures that the coil wedges (41) retain the mechanical strength and durability provided by traditional metallic materials like aluminum or steel, while integrating advanced insulation to prevent arcing, mitigate pitting, and enhance thermal management within the generator environment.

The integrated end cap insulation (43,46) is a key feature, providing critical electrical protection at the points most susceptible to electrical discharge. By preventing electrical arcing between metallic surfaces, the insulation minimizes mechanical wear, mitigates localized heating, and extends the operational lifespan of the generator. This improvement directly targets areas prone to electrical degradation, while eliminating mechanical and thermal stresses caused by recurrent arcing.

To meet these objectives, the present invention provides an affixed insulation block (43,46), typically composed of a machined block of glass-reinforced epoxy laminate. This material is available in industry-standard forms such as NEMA grades FR4, G7, G5, G9, G10, and G11, which are renowned for their high thermal resistance and excellent electrical insulation properties. These qualities make the material ideal for use in high-stress environments such as electric generators.

The insulated block (43,46) is affixed to both ends of the metallic wedge (42,45) through two reliable methods. It can be secured using a non-metallic fastening device (44), which ensures reliable attachment without compromising the insulation's integrity. Alternatively, the block can be bonded to the wedge using a high-performance adhesive (47) specifically designed to withstand mechanical vibrations, high temperatures, and electrical stresses encountered in a running an electrical generator. Both methods ensure a robust and durable bond, providing consistent insulation performance and preventing electrical discharge even under the harsh operational conditions of the generator.

This invention significantly diverges from prior art by integrating insulation (43,46) directly into the wedge (42,45) design, rather than relying on external locking or insulating mechanisms. The invention focuses on methods of affixation (adhesive or non-metallic fasteners (44, 47) ), ensuring secure insulation even under high stress, while the materials used in the integrated end caps improve thermal dissipation and arc resistance. Unlike U.S. Pat. No. 4,015,156, which primarily describes slot wedge locking mechanisms, this invention specifically enhances the wedge block itself, creating an entirely new approach to mitigating electrical and thermal degradation.

The subsequent sections provide a detailed description of the invention, focusing on its structural and functional aspects, methods of affixation, and compatibility with existing generator designs.

### BRIEF DESCRIPTION OF THE DRAWINGS

FIG. 1A illustrates an exemplary prior art generator rotor (11) as viewed from the end along the axis of rotation (13), showing multiple axially extending radial slots (12) arranged around the periphery.

FIG. 1B shows the same rotor (11) from FIG. 1A, viewed orthogonally to the rotor's axis for clarity.

FIG. 2A provides a partially isometric longitudinal section view of a radial slot (12) with a coil winding stack (21) in its operational position. The traditional metallic coil wedge (22) is depicted removed from the rotor for clarity.

FIG. 2B depicts the same radial slot (12) from FIG. 2A with the traditional metallic coil wedges (22) installed in their operational position.

FIG. 2C shows an end view along the axis of rotation (13), illustrating the coil wedge (22) and coil winding stack (21) in the radial slot.

FIG. 2D presents a sectional view, radially through the traditional metallic coil wedges (22) and coil winding stack (21), providing clarity on their configuration.

FIG. 2E shows the separation (23) between adjacent traditional metallic coil wedges (22) within the radial slot (12) in an installed and operational state, highlighting the gap between the end faces of the wedges.

FIG. 3A illustrates the end view of a prior art traditional metallic coil wedge (22), highlighting the arc strike-prone surface.

FIG. 3B shows the same traditional metallic coil wedge (22) from FIG. 3A, viewed orthogonally to the rotor's (11) axis of rotation (13).

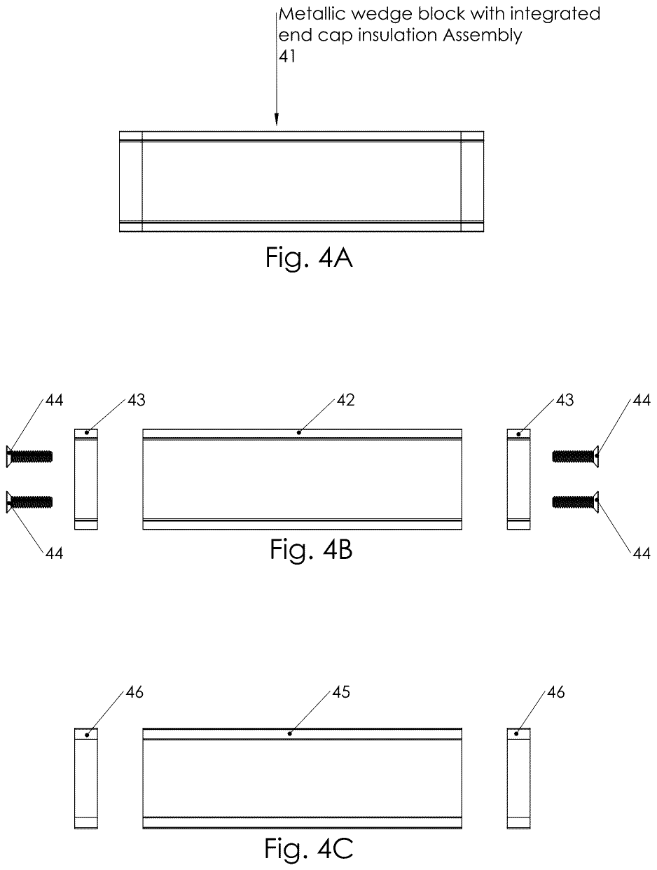

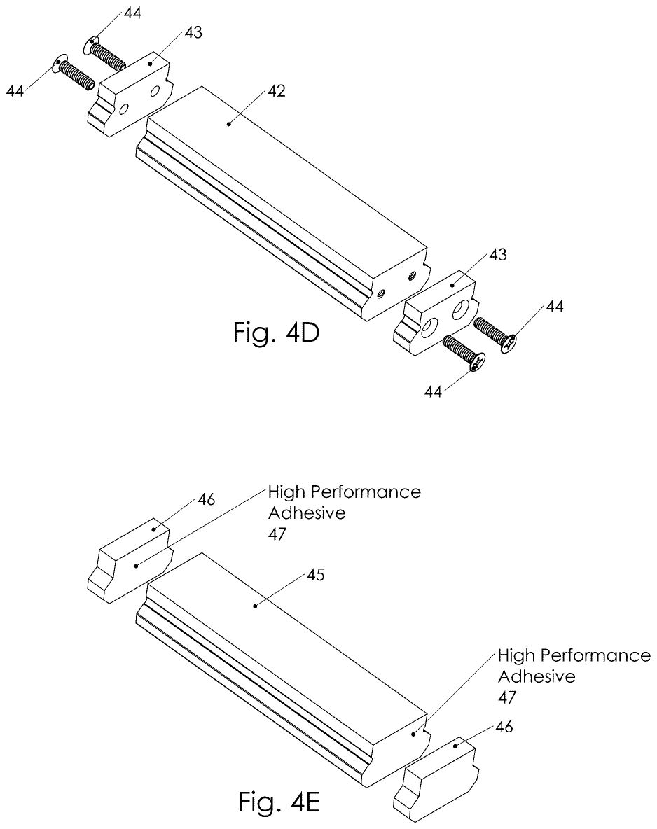

FIG. 4A shows a metallic wedge block with integrated insulated end caps in its assembled form (41) from a top-side view.

FIG. 4B shows a metallic wedge block with integrated insulated end caps (41) from a top side view assembled using the non-metallic fastening device method. The drawing is shown in am exploded parts view state for clarity.

FIG. 4C shows a metallic wedge block with integrated insulated end caps (41) assembled using the high-performance adhesive fastening method. The drawing is presented in an exploded view for clarity.

FIG. 4D is a same exploded parts view as FIG. 4B of the assembly using the non-metallic fastening device method, shown from an isometric perspective for clarity.

FIG. 4E provides the same exploded view as FIG. 4C of the assembly using the high-performance adhesive fastening method, shown from an isometric perspective for clarity. The adhesive application surfaces are labeled on both ends of the wedge.

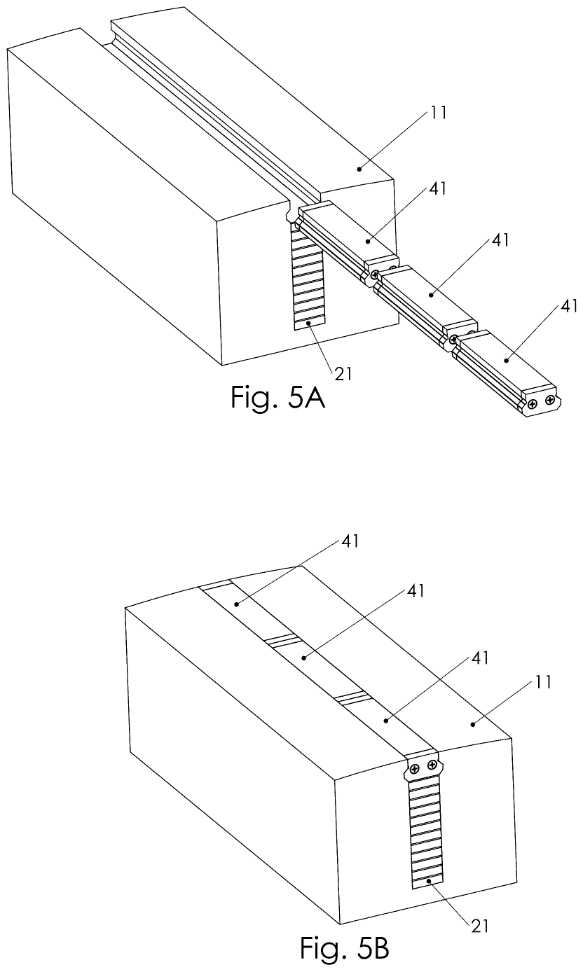

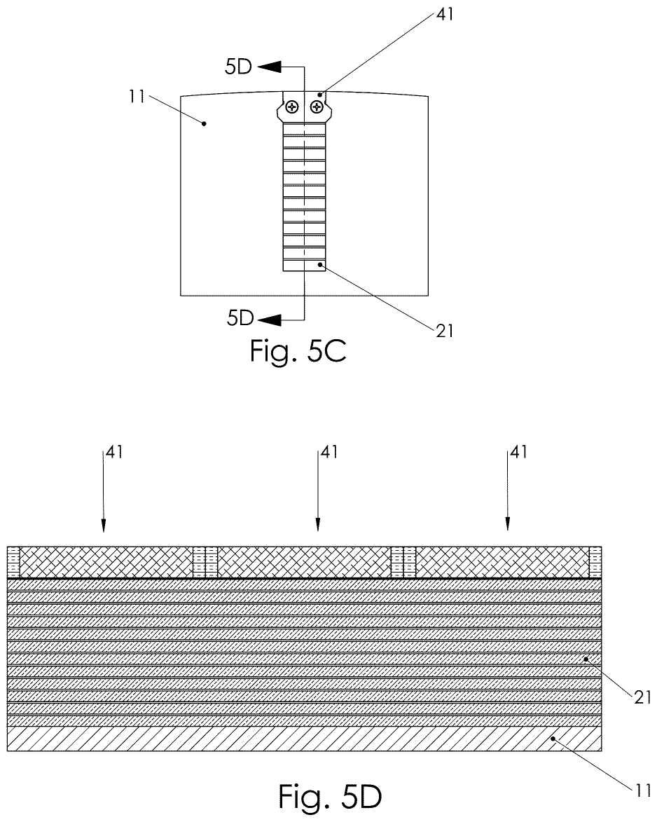

FIG. 5A shows a longitudinal section view of a rotor (11) with a radial slot (12) and coil winding stack (21) installed. The metallic wedge blocks with integrated insulated end caps assemblies (41) are removed for clarity.

FIG. 5B depicts the same radial slot (12) from FIG. 5A with the metallic wedge blocks with integrated insulated end caps assemblies (41) installed in their operational position.

FIG. 5C shows an end view along the axis of rotation (13), illustrating the metallic wedge blocks with integrated insulated end caps assemblies (41) and coil winding stack (21) within the radial slot.

FIG. 5D presents a sectional view radially through the metallic wedge blocks with integrated insulated end caps assemblies (41) and coil winding stack (21), providing clarity on their configuration.

### DETAILED DESCRIPTION OF THE INVENTION

The present invention relates to a metallic wedge block (42) with integrated end cap insulation (43), designed for use in electric generator rotors (11). This invention addresses the mechanical and electrical challenges of prior art metallic coil wedges (22), specifically improving electrical insulation, arc suppression, and mechanical stability under high operational stresses.

### Overview of the Wedge Block Design

Prior art metallic wedge blocks (22), traditionally fabricated from high-strength materials such as aluminum or steel, are designed to be inserted into the radial slots (12) of the generator rotor (11). These wedges secure the winding stacks (21) in place during rotor operation, countering centrifugal forces and ensuring the stability of the rotor windings.

The novel aspect of the present invention lies in the integration of end cap insulation (43, 46) applied to the end faces of a modified metallic wedge block (42, 45). This insulation prevents electrical arcing between metallic wedges (42, 45) and between metallic wedges (42, 45) and the rotor's radial slot (12), particularly under conditions of negative sequence events. This design effectively mitigates electrical arcing, a prevalent issue with traditional coil wedges.

The modified metallic wedge block (45) is manufactured at a shortened length to account for the thickness of the end cap insulation (46), which is affixed to each end using a High-Performance Adhesive (47). Alternatively, if a method employing non-metallic fastening devices (44) is used, the modified metallic wedge block (42) will be both shortened and drilled/tapped to accommodate the fasteners. In this case, the end cap insulation (43) is drilled with corresponding through holes to allow proper alignment and secure attachment using the non-metallic fastening devices (44).

### Function of the End Cap Insulation

The integrated end cap insulation (43, 46) electrically isolates the metallic wedge block from the generator's rotor (11) structure while preventing arc strikes at the interface between the modified metallic wedge block (42, 45) and the rotor (11). This insulation is critical for reducing both mechanical pitting and electrical degradation, which are prevalent issues in traditional generator designs.

The integrated end cap insulation (43, 46) plays a pivotal role in enhancing the generator's operational performance, particularly under conditions of high electrical and thermal stress. By mitigating electrical arcing between wedge blocks and adjacent rotor slots, it prevents arc strikes that can lead to mechanical pitting and surface degradation over time. The insulation creates a robust electrically insulated barrier on each end of the metallic wedge block, significantly reducing the risk of current discharge paths forming between adjacent wedges or from a wedge to the rotor body itself, even during negative sequence events.

Engineered for the harsh environment within a generator, the integrated end cap insulation (43, 46) is designed to withstand high temperatures, mechanical vibrations, and stresses inherent to generator operation. By incorporating advanced insulation materials, the invention ensures electrical discharge is minimized, significantly reducing wear and extending the operational life of both the wedge block and the generator rotor.

The integrated end cap insulation (43, 46) is typically fabricated from glass-reinforced epoxy laminates such as NEMA grades FR4, G7, G9, G10, or G11. These materials provide exceptional electrical insulation and heat resistance, ensuring reliable performance in high-stress environments. The insulation is commonly built to an overall thickness ranging between ¼ inch and ½ inch, optimized for durability and electrical isolation.

### Affixation of the Insulated Block

The integrated end cap insulation (43, 46) is affixed to the metallic wedge block through one of two methods, depending on application and design requirements:
1. Non-Metallic Fastening Devices (44): In one embodiment, the integrated end cap insulation (43) is affixed to the wedge (42) using non-metallic fastening devices, such as screws. These fasteners (44) ensure secure attachment without compromising the insulating properties of the block. The fastening devices (44) are selected for their ability to provide both mechanical strength and electrical insulation, ensuring reliable performance under operational stress. This method is best illustrated in FIG. 4B and FIG. 4D.
2. High-Performance Adhesive (47): In an alternate embodiment, the insulation end cap (46) is bonded to the metallic wedge (45) using a high-performance adhesive (47). This adhesive is selected for its durability under high temperatures and mechanical vibrations encountered in a running generator, ensuring the insulation remains securely affixed throughout the generator's operational life. This method is best illustrated in FIG. 4C and FIG. 4E.

Both affixation methods provide a secure and reliable bond between the metallic wedge block (42, 45) and the integrated insulation end cap (43, 46), maintaining the invention's insulating properties even under the most demanding operational conditions.

Once the integrated insulation end caps (43, 46) are affixed to both end faces of the modified metallic wedge block (42, 45), the assembly becomes a metallic wedge block with integrated insulated end caps (41), as depicted in FIG. 4A.

### Material Property and Thermal Advantages

To further enhance the functionality of the metallic wedge block with integrated insulated end caps (41), the selected materials for the integrated end cap insulation (43, 46) are chosen for their superior electrical and thermal performance. These materials, including glass-reinforced epoxy laminates such as NEMA grades FR4, G7, G9, G10, and G11, are well-documented for their combination of high dielectric strength, thermal resistance, and mechanical durability.

Electrical Properties: NEMA-grade laminates, particularly G10 and G11, provide exceptional electrical insulation, with dielectric strengths typically exceeding 300 volts/mil. These materials effectively isolate adjacent wedge blocks and prevent electrical discharge during generator operation, including negative sequence events.

Thermal Resistance: G10 and G11 grades offer outstanding heat resistance, with operating temperature ranges from −200° C. to 180° C., ensuring reliable performance in high-temperature environments within the rotor. The material's low thermal conductivity prevents excessive localized heating and dissipates thermal loads more uniformly, reducing stress on both the insulation and the metallic wedge.

Mechanical Durability: These glass-reinforced laminates are engineered to withstand significant mechanical stress, including vibration and centrifugal forces encountered during rotor operation. Their rigidity and strength ensure a secure fit within the radial slot (12) while maintaining long-term stability.

By selecting these materials, the integrated end cap insulation (43, 46) provides robust thermal and electrical protection tailored to the high-stress environment of a generator rotor. This choice enhances the rotor's operational efficiency, minimizes maintenance requirements, and significantly extends its service life.

In contrast to prior art, including U.S. Pat. No. 4,015,156, which does not address thermal performance enhancements, the present invention employs advanced materials such as NEMA G10 and G11 laminates, known for their low thermal conductivity and ability to dissipate localized heating. The integration of these materials into the wedge design prevents temperature gradients at the wedge ends, reducing thermal fatigue and improving overall generator efficiency.

### Metallic Wedge Block With Integrated Insulated End Caps Installation

The metallic wedge block with integrated insulated end caps assembly (41) is installed into the rotor's radial slots (12), containing winding stacks (21), using the same installation methods employed for prior art traditional metallic coil wedges (22).

FIG. 5A provides a partially isometric longitudinal section view of a rotor (11) with a radial slot (12) containing a coil winding stack (21) in its operational position. The metallic wedge block with integrated insulated end caps assemblies (41) are depicted removed for clarity.

FIG. 5B depicts the same longitudinal section view from FIG. 5A, showing the metallic wedge block with integrated insulated end caps assemblies (41) installed in their operational positions.

FIG. 5C illustrates the same configuration as FIG. 5B, viewed from an end view along the axis of rotation (13) for clarity.

FIG. 5D presents a sectional view radially through the metallic wedge block with integrated insulated end caps assemblies (41) and the coil winding stack (21), providing further clarity on their configuration.

The metallic wedge block with integrated insulated end caps assembly (41) serves two primary functions once installed:
1. Mechanical Stability: Preventing the outward movement of the coil winding stacks (21) due to centrifugal forces, consistent with the function of prior art traditional metallic coil wedges (22).
2. Electrical Arc Mitigation: Creating an insulating barrier between adjacent assemblies to prevent electrical discharges during generator operation, particularly during negative sequence events.

Although the metallic wedge block with integrated insulated end caps assembly (41) may still experience separation (23) between adjacent assemblies, unlike traditional metallic coil wedges (22), the integrated insulation prevents an arc strike from occurring. The insulating barrier between adjacent wedges eliminates surfaces where arc strikes could otherwise occur. This innovation prevents mechanical pitting damage to the rotor radial slot (12), nearby rotor surfaces (11), and between the coil wedge faces.

### Operational Advantages

The present invention offers several critical operational advantages over prior art designs. Traditional metallic coil wedges (22) suffer from electrical arcing and pitting at installation separation points (23) due to the lack of insulation at these critical areas. This leads to reduced efficiency and a shorter operational lifespan for the generator. In contrast, the present invention mitigates these issues by integrating robust electrical insulation at the end faces (43, 46) of the metallic wedge block (42, 45), where arc strikes are most likely to occur.

The integrated insulation also reduces the thermal load on the rotor by preventing localized heating caused by electrical discharge. This enhancement improves thermal management throughout the generator, allowing for more efficient operation and reducing wear on internal components. By maintaining lower operating temperatures, the invention not only improves efficiency but also minimizes the risk of thermal degradation over time.

By addressing both mechanical and electrical challenges in a unified design, the present invention significantly extends the lifespan of the generator rotor, reduces maintenance demands, and enhances overall generator efficiency. These improvements result in a more reliable and cost-effective solution for modern electric generators.

Thermal Advantages

The integrated insulation utilizes high-grade glass-reinforced epoxy laminates, such as NEMA G10 and G11, for superior thermal performance, which provide exceptional resistance to the high temperatures generated within the generator's rotor. Unlike conventional designs, this insulation effectively dissipates localized heating caused by electrical discharge, maintaining a more uniform temperature profile across the rotor slots. By preventing hot spots from forming at the wedge faces, the insulation preserves the structural integrity of both the wedge block and the rotor slot surfaces.

The ability to reduce localized heat accumulation and dissipate it uniformly across the rotor enhances thermal stability, thereby prolonging the lifespan of the metallic wedge block and minimizing maintenance needs. This improvement directly contributes to greater generator efficiency and reliability, making the system more robust under demanding operational conditions.

### Integration With Existing Generator Designs

The metallic wedge block with integrated insulated end caps (41) is specifically designed for seamless compatibility with both new and existing generator systems. The design ensures that operators can retrofit the invention into existing generator rotors (11) during routine maintenance, overhauls, or system upgrades without requiring modifications to the rotor slots (12), stator configuration, or other structural components.

The retrofitting process utilizes standard installation techniques already familiar to maintenance personnel, minimizing downtime and complexity. For example:
1. Preparation: Existing traditional metallic coil wedges (22) are removed from the radial slots (12), leaving the winding stacks (21) in place.
2. Inspection: The radial slots (12) are inspected for debris, wear, or damage to ensure a proper fit for the metallic wedge block with integrated insulated end caps (41).
3. Installation: The metallic wedge block with integrated insulated end caps (41) is inserted into the radial slot (12) following the same procedure used for prior art wedges, ensuring proper alignment and secure positioning. If the insulation is affixed using non-metallic fastening devices (44), these are tightened according to manufacturer specifications. If the insulation is bonded using high-performance adhesive (47), the adhesive is applied to the specified surfaces (as shown in FIG. 4C and FIG. 4E), and the assembly is allowed to cure for the recommended time.
4. Validation: Once installed, the rotor (11) undergoes standard operational testing to ensure that the retrofitted wedges meet performance criteria, including mechanical stability and electrical insulation effectiveness.

This retrofitting process ensures that operators can upgrade their generators to include advanced insulation and arc mitigation capabilities without requiring expensive modifications to the existing infrastructure. By leveraging the invention's compatibility with legacy systems, operators can achieve significant improvements in generator efficiency and longevity while reducing maintenance costs.

The retrofitting process outlined in the present invention is entirely distinct from prior art systems, such as U.S. Pat. No. 4,015,156, which emphasize locking mechanisms rather than wedge replacements. The compatibility of the metallic wedge block with integrated insulated end caps ensures that no modifications to rotor slot dimensions or stator configurations are required, making the invention uniquely adaptable for direct replacement of traditional metallic wedges.

### Comparison to Prior Art (U.S. Pat. No. 4,015,156)

U.S. Pat. No. 4,015,156 addresses challenges related to the axial locking of slot wedges through external insulating mechanisms. However, it does not propose or describe a solution to mitigate electrical arcing or pitting at wedge end faces, which remain significant operational concerns in dynamoelectric generators.

The present invention diverges significantly from U.S. Pat. No. 4,015,156 in both focus and application. While U.S. Pat. No. 4,015,156 provides a locking mechanism using insulating components to prevent axial movement of slot wedges, it does not address critical issues of electrical arcing, mechanical pitting, or thermal dissipation at wedge end faces. Unlike the prior art, the invention integrates insulation directly into the wedge block, ensuring that arc suppression and thermal management are inherent to the wedge design rather than reliant on external mechanisms.

### SPECIFICALLY

The integrated end cap insulation is directly affixed to the metallic wedge block, eliminating surfaces where arc strikes may occur, even during negative sequence events. This feature is absent in U.S. Pat. No. 4,015,156, which does not modify the wedge itself.

Advanced materials such as glass-reinforced epoxy laminates (e.g., NEMA G10 and G11) are employed for their high dielectric strength, low thermal conductivity, and ability to dissipate localized heat. These materials enable the wedge to maintain thermal stability, reducing fatigue and increasing generator efficiency—a capability not addressed in U.S. Pat. No. 4,015,156.

Methods of affixation using non-metallic fasteners or high-performance adhesives provide a robust, vibration-resistant bond that ensures the insulation remains intact under operational stresses. In contrast, U.S. Pat. No. 4,015,156 focuses on mechanical locking mechanisms unrelated to insulation affixation.

The present invention directly targets these issues by incorporating an insulating component into the metallic wedge block itself, providing localized arc mitigation and enhanced thermal dissipation. Additionally, the use of adhesive or non-metallic fasteners to secure the insulation ensures operational reliability under centrifugal and vibrational stresses, offering advantages that are neither taught nor suggested by the prior art.

I claim.

1. An apparatus for securing coil windings within a generator rotor, comprising: a metallic wedge block configured to fit into radial slots of a generator rotor, providing structural support to prevent movement of coil windings under centrifugal forces during operation; integrated end cap insulation affixed to each end of the metallic wedge block, configured to electrically isolate adjacent wedge blocks and the wedge block from the rotor, thereby preventing electrical discharge and arcing; end cap insulation comprising a glass-reinforced epoxy laminate selected from NEMA grades FR4, G7, G9, G10, and G11, each offering electrical insulation, mechanical durability, and thermal resistance.

2. The apparatus of claim 1, wherein the metallic wedge block and end cap insulation are configured to mitigate arc strikes, thereby minimizing localized heating and preventing mechanical pitting on rotor components.

3. The apparatus of claim 1, wherein the end cap insulation is affixed to the metallic wedge block using non-metallic fastening devices, ensuring insulation integrity under mechanical and thermal stresses.

4. The apparatus of claim 1, wherein the end cap insulation is affixed to the metallic wedge block using a high-performance adhesive with high thermal tolerance and vibration resistance, ensuring long-term adhesion under operational conditions.

5. The apparatus of claim 1, wherein the metallic wedge block is composed of a material selected from the group consisting of steel and aluminum, chosen for its ability to provide high mechanical strength and durability under centrifugal forces, while maintaining compatibility with generator rotor operational requirements.

6. The apparatus of claim 1, wherein the end cap insulation features beveled or contoured profile designed to conform closely to the geometry of the radial slot, maximizing contact area and improving mechanical stability and electrical insulation.

7. A method of securing coil windings within a generator rotor, comprising: Positioning a metallic wedge block, equipped with integrated end cap insulation, into a radial slot of a generator rotor; affixing the insulation to the wedge block using either a non-metallic fastening device or a high-performance adhesive; whereby the insulation prevents arcing between adjacent wedges and improves thermal management within the rotor.

8. The method of claim 7, wherein the end cap insulation is designed to mitigate the effects of negative sequence events, reducing the occurrence of electrical arc strikes and minimizing pitting on rotor surfaces.

9. The apparatus of claim 1, wherein the integrated end cap insulation comprises multiple laminated layers of glass-reinforced epoxy, each layer engineered for specific dielectric and thermal properties, including enhanced arc suppression, uniform thermal dissipation, and resistance to vibrational stresses, thereby providing comprehensive protection against electrical and thermal degradation.

10. The apparatus of claim 1, wherein the metallic wedge block is configured with surface texturing or grooves to enhance adhesive bonding or interlocking with non-metallic fasteners, thereby increasing the reliability of the affixation under operational stresses.

11. The method of claim 7, further comprising retrofitting the metallic wedge block with integrated end cap insulation into an existing generator rotor by replacing traditional metallic coil wedges, wherein the retrofitting is performed using standard installation techniques, without requiring modifications to the rotor slots, stator configuration, or other structural components of the generator.

12. The apparatus of claim 1, wherein the integrated end cap insulation is configured to electrically isolate the end faces of adjacent wedge blocks, preventing electrical discharge and arcing across separation gaps that may occur during generator operation, including negative sequence events.

13. The apparatus of claim 1, wherein the integrated end cap insulation incorporates a design enabling retrofitting into existing generator systems, eliminating the need for modifications to rotor slot dimensions, stator configurations, or other structural components, thereby providing a cost-effective upgrade path for enhanced arc mitigation and thermal performance.
